(19) United States
(12) Patent Application Publication
(10) Pub. No.: US 2017/0029087 A1
(43) Pub. Date: Feb. 2, 2017

(54) TETHER GRIP ASSEMBLY, SYSTEM FOR TETHERING A BUOYANT DEVICE AND METHODS FOR THE SAME

(71) Applicant: Raven Industries, Inc., Sioux Falls, SD (US)

(72) Inventor: Patrick William Lokken, Harrisburg, SD (US)

(21) Appl. No.: 15/223,450

(22) Filed: Jul. 29, 2016

Related U.S. Application Data
(60) Provisional application No. 62/198,516, filed on Jul. 29, 2015.

(51) Int. Cl. B64B 1/66; H02G 11/02; B66D 1/12; B60L 9/00

(52) U.S. Cl. CPC B64B 1/66; B60L 9/00; H02G 11/02; B66D 1/12; B60L 2200/10

(57) ABSTRACT

A method of securing a tether to a buoyant inflatable device is described. The method includes providing a tether grip assembly comprising an eye with a support thimble. The tether is coupled with the tether grip assembly. The tether grip assembly is configured for coupling with the buoyant inflatable device by routing the tether through a tether passage of the tether grip assembly surrounded by a braided shell of the tether grip assembly, penetrating the tether through the braided shell at an emergence point, and delivering a first portion of the tether through the emergence point in the braided shell and retaining a second portion of the tether in the tether passage.

### CROSS-REFERENCE TO RELATED APPLICATIONS

This application claims priority to U.S. Provisional Application No. 62/198,516, titled “TETHER GRIP ASSEMBLY, SYSTEM FOR TETHERING A BUOYANT DEVICE AND METHODS FOR THE SAME,” filed on Jul. 29, 2015, the disclosure of which is incorporated herein by reference as if reproduced herein in its entirety.

### BACKGROUND

Inflatable buoyant devices such as dirigibles, aerostats, atmospheric balloons, towing gliders, balloons and the like are used for a variety of functions including transportation, observation and communication. One example of buoyant devices is an aerostat. Aerostats are, in some examples, tethered to provide one or more of observation, communication or sensory capabilities. In the case of a tethered aerostat, tether grips provide a mechanical interface between the aerostat and the tether which anchors the aerostat to the ground-based mooring platform. Where the aerostat requires communication to the ground and/or power from a power supply the tether optionally includes an electro-optical-mechanical (EOM) tether.

In at least some examples, tether grips include a plurality of separated tassels that meet at a central location near an eyelet. The separated tassels are wound around the tether by hand or in an automated fashion to couple the tether grip with the tether. In other examples, electrical tape, nylon cord or the like is wound around the separated tassels (now wound) to hold the tassels in place around the tether. Additionally, hollow tether grip shells are known, but have not allowed for EOM tethers to reach the aerostat, as the tether generally terminates within the hollow grip.

### OVERVIEW

The present inventor has recognized, among other things, that a problem to be solved is that current inflatable device aerostat) tethering systems require a great deal of time to install, require a myriad of steps to install, at times result in improper gripping and unacceptable tether system breaking strength, and may not allow for the EOM tether to reach the aerostat payloads. For example, known tethering installation techniques require the installer to braid strength member strand bundles from either a separate tether grip, or potentially from the internal strength members of the tether itself, around the tether in multiple layers at the termination point of the tether. In the case of using the tether's own strength members, it's required that the outer protective jacket be removed several feet from the end of the tether to access said members. This introduces a path for environmental contaminants to include moisture, particulates, and ultraviolet waves. The requirement of braiding these strand bundles around the tether is extremely time consuming and introduces the increased possibility of human error in securing the tether. Such error can results in loss or damage to the aerostat and payload.

Additionally, while certain tether grips that are hollowed out and surround the end of the tether are known (see, e.g., the YaleGrip™ TechEye 10 grip, available from Yale Cordage Inc. (Saco, Me.)), such grips have not previously provided for or allowed for the tether to continue on to the aerostat after it has been secured. This has meant that such hollow grip products have not been used in applications where the tether must deliver, e.g., power and communication signals, such as in the case of an EOM tether.

The present subject matter helps provide a solution to these problems with a tethering system and associated grip installed in far less time and with less complication. Further, the tethering system and grip described herein consistently increases the average breaking strength of a tethering system for buoyant inflatable devices to correspondingly minimize loss or damage to aerostats and payloads. Additionally, the tethering system and grip described herein is capable of at least two installation states, one in which the end of the tether is inserted into the tether passage and another in which the end of the tether extends towards the aerostat and through a wall of a braided shell.

The present solution includes a tether grip, and tethering system that utilizes the tether grip as described herein. In one example, a tether is routed through a tether passage (e.g., of a braided shell) of the tether grip. The tether penetrates the braided shell surrounding this tether passage. The braided shell, when loaded in tension (e.g., tension in the tether), transforms the tension into a compressive load applied around the tether. The remaining portion of the tether penetrated through the braided shell is routed to the payload of the aerostat, for instance to provide power and data communication.

Additionally, the tether grip described herein includes a support thimble in the eye of the tether grip. This loop of braided tether grip (eye) and support thimble act as the reinforced eye to which the aerostat may be attached, and the thimble aids in reducing risk of break by providing abrasion resistance and force distribution.

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 provides a perspective view of one example of a tethering system for an inflatable buoyant device.

FIG. 2 provides a side view of one example of a tether grip kit.

FIG. 3 is a side view of a tether exiting an emergence point in the wall of the hollow braided portion of an example tether grip.

FIG. 4 is a cross-sectional view of a fid according to the present description.

FIG. 5 is a side view of the fid of FIG. 4.

FIG. 6 is a cross-sectional schematic of another example of a tethering system that is to be used as the tethering system of FIG. 1.

FIG. 7A-7C provide cross-sectional views of a first installation state of another exemplary tether grip assembly and a second installation state of the tether grip assembly.

FIG. 8 is a block diagram showing one example of a method of securing a tether to a buoyant inflatable device.

### DETAILED DESCRIPTION

As noted above, previously practiced methods for gripping tethers, including EOM tethers, are time-consuming and complicated and suffer the drawback of improper gripping, and therefore a reduced average breaking strength. Of course, any break in an aerostat tethering system can result in the loss of the aerostat itself and financial loss to the owner. In examples, the present subject matter provides a tether grip and tethering system that incorporates such a grip, that is more quickly installed, requires fewer materials, reduces damage to the tether material when under load, increases the breaking strength of the system as a whole, and allows for transportation of the EOM tether to the aerostat payload system.

Tether grips provide a mechanical interface between the aerostat and the EOM tether, which anchors the aerostat (or other inflatable buoyant device) to the ground mooring platform. To date, the methods for gripping EOM tethers are time consuming and complicated, which provides opportunity for improper gripping. This improper gripping causes one or more of the grip or grip tether interface to be the weak point in the system, ultimately reducing the overall strength and increasing the opportunity for breaking along the tether and loss of one or more of an inflatable device, payload or the like.

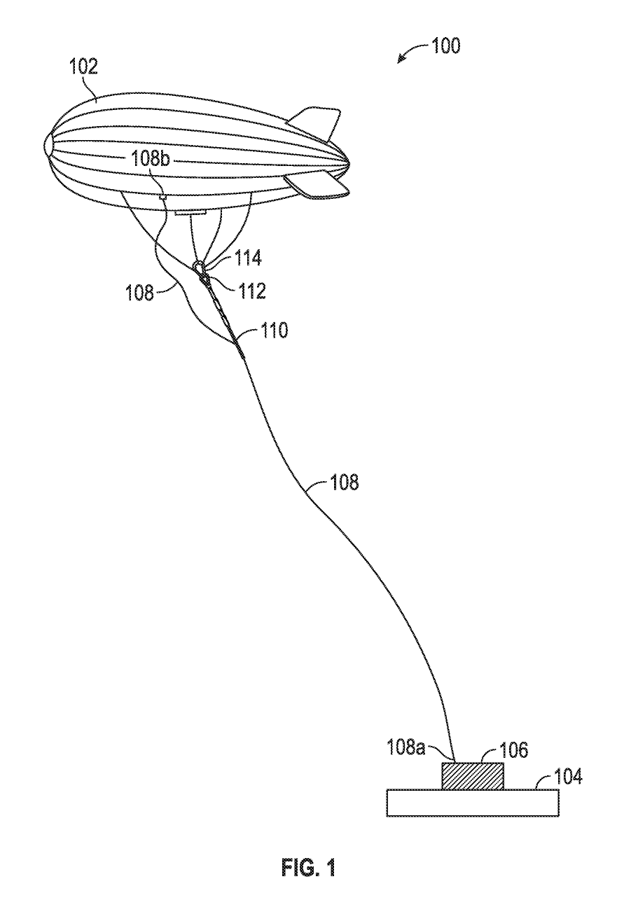

An example of a tethering system for a buoyant inflatable device, such as an aerostat, is illustrated in FIG. 1. In one example, the system 100 includes a buoyant inflatable device 102 and an optional ground platform 104. The ground platform 104 includes a winch 106 in another example. A tether 108 is secured to the winch at a first end 108a and is secured to inflatable device 102 at a second end 108b. The system includes a tether grip assembly 110 secured to the tether 108. The tether grip assembly 110 includes a hollow portion (e.g., a braided shell through which tether 108 passes) and an eye 112 that includes a thimble. The eye 112 is secured to the inflatable device 102 with a robust securing mechanism including, but not limited to, a latch 114 coupled to the inflatable device 102. The tether grip assembly 110 is described in detail herein.

In one example, the tether grip assembly 110 includes a rope pulling eye constructed with robust materials (e.g., materials able to maintain structural integrity when subjected to forces including 10,000 pounds or more of tension transmitted from the tether 108 to the inflatable device 102 shown in FIG. 1). The tether grip assembly 110, in an example, includes a synthetic para-aramid fiber rope pulling eye, such as a Technora® (Teijin Aramid BV, Netherlands) rope pulling eye. Another example of a rope pulling eye is a YaleGrip™ TechEye 10 grip. Accordingly, in at least some examples the hollow tether grip assemblies described herein are constructed, at least in part, of a robust para-aramid fiber, such as Technora®. Additionally, the rope pulling eyes utilized in the present description are both abrasion-resistant and UV-resistant due to the environmental conditions of the in service tether grip assembly 110 (e.g., high altitude, extreme temperature fluctuations, UV exposure or the like). Further, the robust character of the tether grip assembly 110 increases the operational lifetime of the system and correspondingly minimizes the failure of the system 100 and loss of the inflatable device, such as an aerostat. The present disclosure modifies and enhances rope grips to facilitate permanent and robust use to tether inflatable devices in a variety of environmental conditions and under extreme loads including 10,000 pounds or more of tension.

As will be discussed in greater detail, in the presently described embodiments, the tethering systems described herein provide exemplary tether grip assemblies (e.g., the assembly 110) that receive and deliver the tether through the walls of assembly, such as a braided shell. Stated another way, the tether is received within a passage of the tether grip assembly and a passage is formed through the braided shell (at an emergence point) to facilitate the extension of the tether beyond the assembly. The tether extends several feet past the emergence point through the braided shell of the hollow tether grip. The extended tether is then delivered to the payload systems (e.g., electronics, guidance systems or the like) under minimal stress as load along the tether is transferred to the tether grip assembly and to the inflatable device 102, for instance through the interface of the eye 112 and the latch 114. Further, the tether grip assemblies described herein include other features including, but not limited to, a robust thimble (e.g., stainless steel, aluminum or the like) positioned within the rope eye. The thimble minimizes failure at the eye 112 and latch 114 interface by providing abrasion resistance and force distribution. Additionally, the tether grip assemblies described herein optionally include a sleeve positioned around a portion of the assemblies. The sleeve provides UV protection for the tether grip, in addition to securing the thimble in the eye. Further, the tether grips described herein include synthetic sleeves that provide for both UV protection of the tether grip, as well as particulate protection of the tether grip. In one example, the synthetic sleeve will be a nylon sleeve.

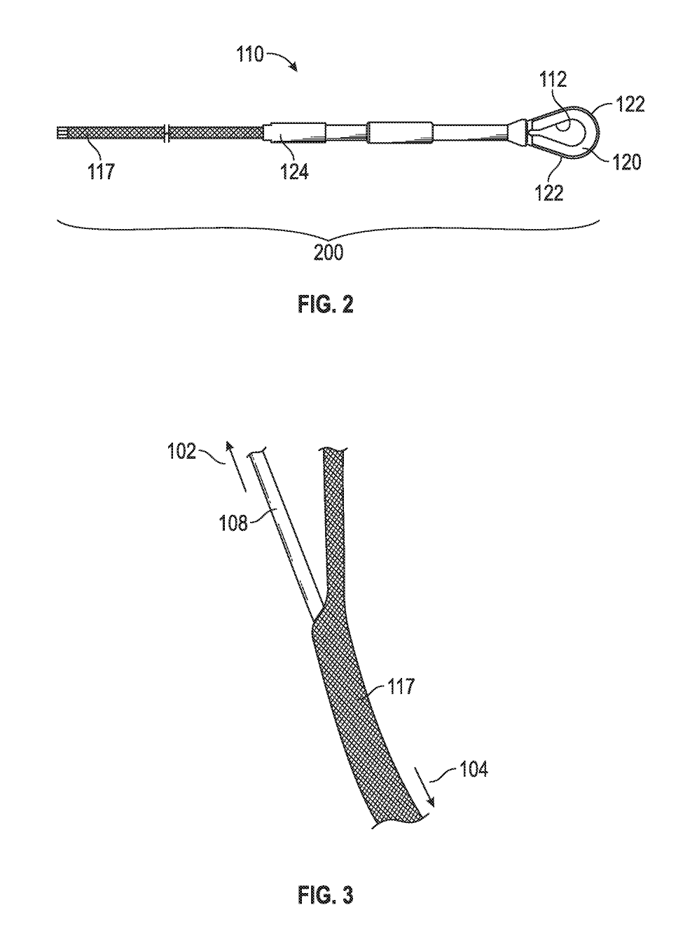

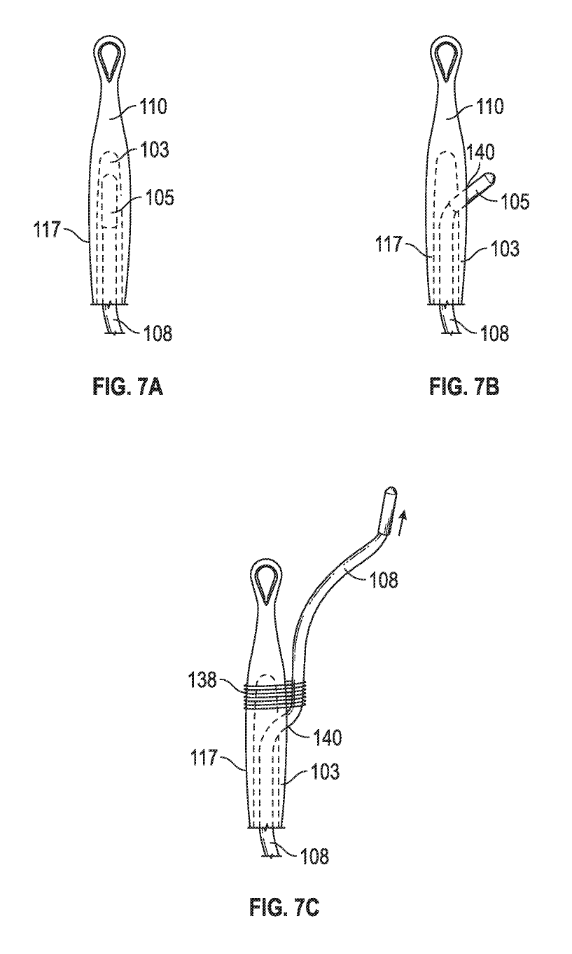

FIG. 2 illustrates an example of one tether grip kit 200 according to the present description. Tether grip kit includes a tether grip assembly 110 that is configured to grasp a tether, such as tether 108. The tether grip kit includes a tether grip assembly 110 that includes a braided shell 117 and a tether passage (e.g., either passage 103 of FIG. 7a) surrounded by the braided shell 117. In an example, the tether passage is a hollow portion within the braided shell as described herein. Additionally, the tether grip assembly 110 includes a support thimble 120 with an eye 112 that extends through the support thimble 120. In one example, the support thimble is constructed with metal, and in at least one embodiment, includes stainless steel. Additionally, the eye 112 is be formed in part by thimble portions 122 of the tether grip assembly that extends around the support thimble 120 in an example. In another example, an anchor sleeve 124 is coupled around the tether grip assembly 110. The anchor sleeve 124 extends toward the support thimble 120 and anchors the thimble portions 122 around the support thimble. For instance, the anchor sleeve 124 extends around portions of the braided shell 117 (shown herein) and retains the thimble portions 122 (e.g., in the manner of a hoop) within a groove of the support thimble 120.

The anchor sleeve 124 optionally includes a UV-protective material that protects at least a portion of the tether grip assembly from UV exposure. In an example, the anchor sleeve 124 is made, at least in part, of rubber. Additionally, in one example the anchor sleeve 124 includes at least a portion that is made of a cold shrink material that clamps the anchor sleeve 124 around the braided shell (within the sleeve).

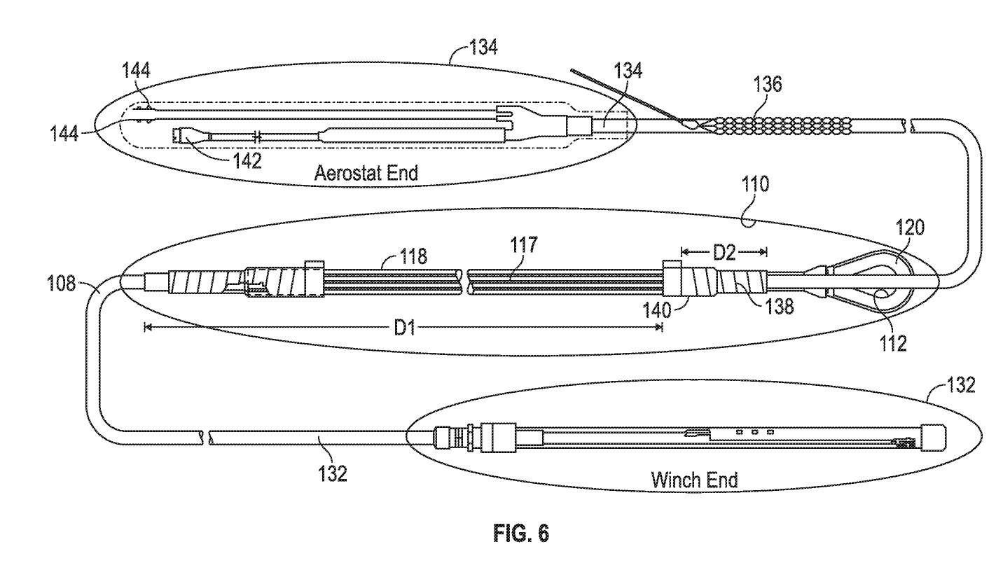

Further, in an example, a sleeve 118 (FIG. 6), e.g., a Nylon sleeve, extends along the length of the tether grip assembly. The sileeve 118 provides additional UV protection for the tether grip assembly 110.

As discussed herein, the presently described tether system 100 and tether grip assembly 110 utilized in the system provide advantages over the prior art. For instance, the tether grip assembly 110 enhances the average breaking strength of a system utilizing a tether grip (e.g., consistently resists forces of 10,000 lbf or greater). Because the tether grip assembly 110 withstands these strong forces and is less likely to be improperly installed (as described herein), the systems including the tether grip assembly 110 resist breakage from forces that equal or exceed the average breaking strength of the tether itself or the latches secured to the tether.

In some examples, both the tether grip assemblies 110 described herein, and systems incorporating such assemblies exhibit an average breaking strength of greater than 10,000 lbf, and greater than 15,000 lbf, greater than 18,000 lbf, or even greater than 20,000 lbf.

The interface of the tether grip assembly 110 to the tether (e.g., tether 108 in FIG. 1) reduces damages to the tether 108 from the tether grip assembly 110 when the system 100 is under load. Additionally, the tether grip assembly 110 and method of installation (described herein), decreases installation time and errors in installation. In some examples, the decrease in time with the tether grip assembly 110 is approximately one hour relative to other grip assemblies having a four hour (or longer) installation time (e.g., a 75 percent time savings over previous installation methods). Further, the method of installation minimizes user error with the installation of other grip assemblies. Further still, the tether grip assembly 110 described herein uses approximately half of the materials of other tether grip systems.

As discussed, in the presently described tether system 100, the tether 108 is routed from inside a hollow interior of the shell 117 of the tether grip assembly, through the shell wall and ultimately to the aerostat 102. FIG. 3 illustrates this portion of the system with the tether 108 routed through the tether passage 103 (FIG. 7A) and emerging outside the wall of the braided shell 117 to be routed towards buoyant inflatable device 102 (FIG. 1). The direction towards ground platform 104 is also illustrated.

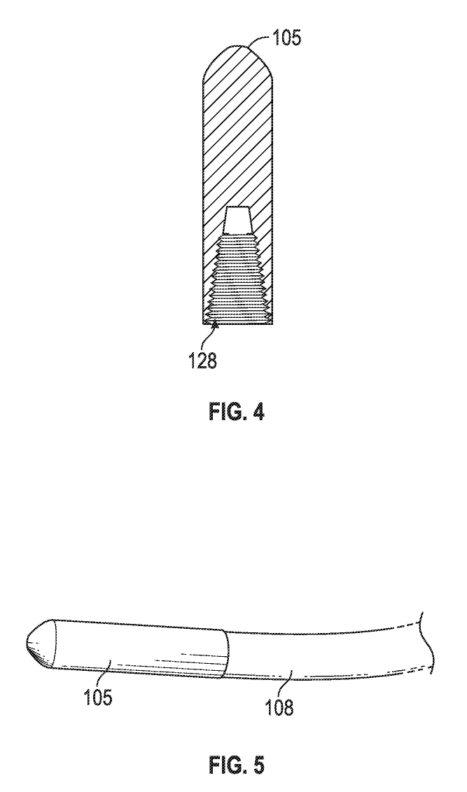

In one example, a fid is used to aid in transporting the tether through the tether grip wall. The fid is part of the tether grip kit in one example. FIG. 4 illustrates a cross-sectional view of a fid 105 used in the present description. As illustrated, the fid 105 includes a fastening feature, such as threading 128 to secure the fid to an end of the tether 108. In another example, the fastening feature of the fid 105 includes, but is not limited to, internal bars, grooves, clamps or the like, configured to grasp and retain the end of the tether 108 to the fid 105. The tether 108 with fid 105 present on the end is routed through the hollow portion of the shell 117 of the tether grip assembly 110 then routed through the wall of the braided shell 117. The shape of the fid 105 minimizes snagging of the grip fibers (e.g., the fibers included in the braided shell 117) as the fid 105 and tether 108 are passed through the wall of the braided shell 117. Generally, the braided shell 117 includes one or more perforations between fiber braids (e.g., fibers, bundles of fibers, or the like) and the perforations are configured to receive and pass the fid 105 and tether 108 from the tether passage 103 therethrough. The fid 105 and tether 108 exit through the perforation at an emergence point 140. The tether 108 (extending through the perforation) is then routed to the aerostat for connection (e.g., with one or more of payload, control systems, instruments or the like).

Feeding the tether 108, for instance with the fid 105 minimizes the snagging of tether grip shell 117 fibers and thereby enhances the integrity and overall strength of the grip when installed. The fid 105 (one example is shown in FIG. 4) is configured to fit a wide range of tether diameters (relative to other available fids). Accordingly, the fid 105 is used with a wider variety of tether systems including tethers of varying diameters. FIG. 5 provides a side view of a perspective view of the fid 105 used in the presently described system. As shown, the tip of the fid 105 is more blunt than the tips of other commonly available lids. This aids in minimization of snagging of the tether fibers.

FIG. 6 provides another illustration of the tether system incorporating the tether grip assembly 110 according to the present description. The tether grip assembly 110 is illustrated in the center of the schematic diagram and corresponds to the tether grip assembly 110 illustrated in FIG. 2. Of note, FIG. 6 illustrates that the tether 108 extends within the braided shell 117 for a first distance D1. The tether 108 then emerges at an emergence point 140 (beneath the wrap 138). The braided shell 117 grasps the tether 108 along at least the first distance, and tightens its grip with tension applied to the tether 108. Tether 108 is optionally further secured to the braided shell along a second distance D2 by a wrap 138. This is done to secure the grip in place even while the system is not under tension. The remainder of the tether 108 is routed independent of the tether grip assembly 110 toward the aerostat (e.g., aerostat 102 shown in FIG. 1). In one embodiment, the tether 108 is secured to the outside of the braided shell 117 along distance D2 by a wrap 138 including, but not limited to, electrical tape.

The schematic in FIG. 6 further illustrates that, in one example, the tethering system 101 includes a cable support grip 136 positioned between the buoyant inflatable device (e.g., the aerostat 102) and the tether grip assembly 110. The cable support grip 136 is positioned proximate a second end (or aerostat end) 134 of the tether 108 that is opposite the first end (or winch end) 132. The cable support grip 136 provides strain relief for the tether 108 at the connection point to the aerostat 102, the aerostat payload or the like. FIG. 6 also illustrates the sleeve 118 extending from the entry point of the tether 108 into the tether passage of the braided shell 117 to a position proximate the thimble 120 and eve 112. The sileeve 118, in one embodiment, includes Nylon. Optionally, the sleeve 118 provides UV protection for the tether grip assembly 110. FIG. 6 further illustrates that, in one example, tether 108 includes a power channel 142 and a communication channels 144, each of which are routed to the aerostat 102. The power channel 142, in one example, includes a power line (e.g., a copper cable) and the communication channel includes one or more fiber optic cables. The connection points of each of the power channel 142 and communication channels 144 will be exposed once the tether 108 reaches the aerostat 102, at which point, the EOM tether is be connected to appropriate connection points on the aerostat 102.

One aspect of the tether grip kits described herein is illustrated in greater detail in FIGS. 7A, 7B and 7C. The tether grip assembly 110 described herein is configured to interface with the tether 108 in at least two installation states. FIGS. 7A and 7C illustrate these installation states. FIG. 7A illustrates the first installation state with the tether grip assembly 110 configured to interface with a tether 108. In this state, the tether 108 is inserted into the tether passage 103 within the braided shell 117. As shown, the braided shell 117 remains in a braided configuration during installation of the tether 108 and is not unwound. Tether 108, in an example, includes a fid 105 positioned on the end of the tether (as shown). One example of a fid 105 is shown in FIG. 5.

In an intermediate state, illustrated in FIG. 7B, the tether 108 (with the optional fid 105) penetrates the wall of the braided shell 117 at an emergence point 140. In an example, to maximize the integrity of the system and maintain optimal breaking strength of the tether grip assembly 110, the fid 105 penetrates the braided shell 117 between two of the fiber bundles that make up the braided shell 117 and not between the individual fibers of a bundle. In another example, the tether 108 is fed through fibers of the braided shell 117.

In the second installation state, illustrated in FIG. 7C, the tether 108 extends toward an inflatable article, such as an aerostat, through the wall of braided shell 117. As further illustrated the tether 108 is optionally secured along the outside of the tether grip assembly 110 by a wrap 138. The tether 108 is optionally routed to the inflatable article (e.g., the aerostat 102) to deliver one or more of data or power (e.g., power, telecommunication feeds, sensory information, control signals or the like) that it is intended to transmit to/from the aerostat.

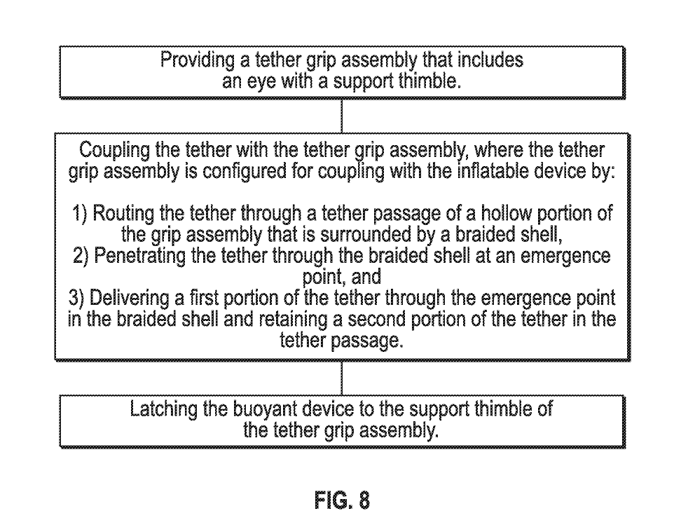

In another aspect, the present description relates to a method of securing a tether to a buoyant inflatable device. FIG. 8 provides a block diagram of one such method. The method includes at least the steps of providing a tether grip assembly 110 comprising an eye 112 with a support thimble 120; coupling the tether 108 with the tether grip assembly 110; and latching the buoyant device 102 to the support thimble 120 of the tether grip assembly 110. As detailed in the second step in FIG. 8, in one example the tether 108 is coupled with the tether grip assembly 110 with the following sub-steps: 1) routing the tether 108 through a tether passage 103 of a hollow portion of the tether grip assembly 110 surrounded by a braided shell 117 of the tether grip assembly; 2) penetrating the tether 108 through the braided shell 117 at an emergence point 140; and 3) delivering a first portion of the tether 108 through the emergence point 140 in the braided shell 117 and retaining a second portion of the tether 108 in the tether passage 103. Optionally, the second step in FIG. 8 includes the sub-step of installing a fid 105 onto an end of the tether 108 before routing it through the tether passage 103 and penetrating the braided shell 117. In one example, the fid 105 is installed onto the end of the tether 108 by screwing the fid 105 onto the end with internal threads 138 within the fid 105.

Additionally, in an example, the method includes routing the first portion of the tether 108 to the buoyant inflatable device 102 (e.g., an inflatable article such as an aerostat or the like). Where an EOM tether is used, the power channel 142 and communication channel(s) 144 are, in one example, exposed at a point near the buoyant inflatable device 102 and are coupled to connections, such as power and data ports, at the buoyant inflatable device, thereby providing power and communication to the device. In one example, in order to provide strain relief for the tether, the method additionally includes the step of securing a cable support grip 136 to the first portion of the tether 108 proximate the buoyant inflatable device 102. Additionally, in one example, the method includes the step of securing an anchor sleeve 124 around the tether grip assembly. The anchor sleeve 124 extends toward the support thimble 120, anchoring the support thimble 120 within the eye 121 of the tether grip assembly 110. Further, in one example, the method includes the step of applying a sleeve 118 around the tether grip assembly 110 (such as the UV-protective nylon sleeve described herein) between the tail portion of the tether grip assembly 110 and the eye of the tether grip assembly 110. Also, in an example, the method includes providing a first wrap around the braided shell 117 and the tether 108 proximate the entrance to the tether passage 103 and providing a second wrap 138 around the tether grip assembly 110 and a length of the tether 108 that is routed through the wall of the braided shell 117. In another example, the second wrap 138 is positioned proximate the emergence point 140. Optionally, the first and second wraps are be an electrically insulating wrap, such as electrical tape.

### Installation Method Prophetic Examples

Various methods of installing a tether system that incorporate a tether grip will now be described. The following materials are utilized in the method examples: 1) silver marker, 2) Yale TechEye 10 Grip, 3) a fid, 4) a 3M three-quarter inch Super 33+Black Electrical Tape (3M Company, Maplewood, MN), 5) 3M 8424-8 cold shrink wrap, 6) black protective nylon sleeve, 7) a cable support grip (Hubbell Wiring Device—Kellems, Shelton, Conn.), and 8) a hacksaw. In other examples, other types of materials, equipment, instruments and tools are used with the present methods.

Various steps of the methods are included in the description that follows. Although described with reference to a particular order, the steps are in other examples performed in other orders to achieve the same result.

Step 1: Determine if a re-termination procedure is being performed. If performing a re-termination, where there is already a tether grip assembly 110 installed, perform Steps 2 through 21. If this is a new tether grip assembly 110 without a tether grip assembly 110 already installed, perform Steps 4 through 21.

Step 2: Measure a length of the tether 108 from the tail end 134 of the tether 108 connected to the inflatable device 102, such as at second end 108b. For example, measure 10 feet from the tail end 134 of the installed tether grip assembly 110 toward the main winch end 132, such as first end 108a, of the tether 108. Make a mark with a silver marker or another appropriate marker or instrument. Other lengths of the tether grip assembly 110 as measured from the tail end are used in other examples.

Step 3: Cut off the measured length of the tether 108. For example, use a hacksaw, to cut the tether 108 off at the mark made in Step 2. Other cutting tools and devices, such as saws are used in other examples. The cut-off tail end will now be the new tail end or aerostat end 134 (or second end 108b).

Step 4: Measure a length of material from the cut-off aerostat end 134 of the tether 108 that will be connected to the inflatable device 102. For example, measure 37 feet from the aerostat end 134 of the tether 108 and mark a line with silver marker all the way around the tether 108.

Step 5: Install the fid 105 onto the aerostat end 134 of the tether 108 by threading the fid 105 on using threading 128 until firmly attached. In other examples, a fid 105 is attached to the tether 108 by other fastening features, such as via force fit, pinned coupling, clamps or welding.

Step 6: Slide a length of a protective sleeve over the tether 108. For example, slide 12 feet of black protective sleeve 118 onto the tether. The protective sleeve 118 is slid past the mark made in step two in an example.

Step 7: Slide a cold shrink tube 124 onto the tether. For example, slide an 8424-8P Cold Shrink tube onto the tether with the pull-tab end first, towards the main winch 106. The cold shrink tube 124 is slid past the mark made in Step 4 in an example.

Step 8: Open a tail end of the tether grip assembly to receive the tether 108. For example, open a tail end of grip shell 117 by pushing the “tails” of the fiber bundles radially outward from the center.

Step 9: Begin sliding the tether grip assembly shell 117 over the fid 105. Avoid snagging the shell 117 and shell fibers with the end of the fid 105. The tether grip assembly 110 is pushed over the fid 105 versus being pulled to facilitate ease of installation. Push the shell 117 two to three inches at a time to threes the shell 117 open and allow more internal area to prevent snagging.

Step 10: Continue step 9, e.g. sliding the tether grip assembly 110, until the tip of the fid 105 reaches approximately three to five inches from the black cold shrink tube 124 covering the neck of the tether grip assembly 110.

Step 11: Slide the tether grip assembly 110 in order to penetrate the braided shell 117 of the tether grip assembly 110 between two of the large fiber bundles of the braided shell 117, such as at emergence point 140. Penetrate the wall of the braided shell 117 with the fid 105 and push the tether grip assembly 110 down until the mark made in Step 4 aligns with the tail end of the tether grip assembly 110.

Step 12: While securing the tail end of the tether grip assembly 110, grip at the mark with one hand, use your other hand to pull the tether grip assembly 110 away from the tail end. This will make the tether grip assembly lay flat and taught on the tether 108.

Step 13: Anchor the tail end of the tether grip 136 to the tether 108. For example, tightly anchor the tail end of the tether grip assembly 110 to the tether 108 with electrical tape. Overlapping both sides of the tail of the tether grip assembly 110 by approximately three inches and make two to three passes (layers) with the tape.

Step 14: Pull the tether grip assembly 110 toward the aerostat end 134 of the tether 108 while anchoring the stainless steel thimble 120. For example, have one person grab the tether grip assembly 110 proximate the stainless steel thimble 120 and firmly pull the tether grip assembly 110 towards the aerostat end 134 of the tether 108, while having another person grab the tether grip assembly 110 at the tail end. While squeezing the tether grip assembly 110, pull towards the thimble 120. This step is optionally performed twice or multiple times until the location along the tether grip assembly 110 including the penetrated tether 108 has stopped moving in relation to the tether 108. This indicates that the tether grip assembly 110 is fully extended. Maintain tension on the grip 136 until after Step 15.

Step 15: Anchor the neck of the tether grip assembly 110 to the tether 108 such as between the emergence point 140 and an end of shell 117. For example, tightly wrap the neck of the tether grip assembly 110 and the tether 108 with electrical tape. In an example, this is done just above i.e., toward the thimble 120) where a clear heat-shrunk label is typically found on commercially available tethers. The wrap is, in an example, approximately four inches long and includes two to three layers between emergence point 140 and thimble 120.

Step 16: Slide the cold shrink tube 124 over the tail end of the tether grip assembly 110. The cold shrink tube 124 is optionally centered at the tail end of the tether grip assembly 110.

Step 17: Tension in the cold shrink tube 124 is released to compress the tether grip assembly 110. For example, while holding the cold shrink tube 124 in place, the spiral core of the cold shrink tube 124 is pulled out. The spiral core is used to maintain cold shrink tubing in an expanded state so that a body (e.g., the tether) is readily inserted into the core before the cold shrink tube is collapsed. The spiral core is readily removed by unwinding from between the body and the cold shrink tube. As the spiral core unwinds, unwrap the loose tail in a counter-clockwise direction to prevent the tail from binding around the tether 108. Excess tail is optionally cut off throughout this process to prevent the excess tail from interfering with other aspects of the performing the method.

Step 18: Mark all the way around the tether 108 and the tether grip assembly 110 at each end of the cold shrink tube 124. The markings are used as indicators to grip movement during operation. For example, the marker is used to mark on the tether 108 and the tether grip assembly 110. Alternatively, a piece of electrical tape is used to provide one or more markings.

Step 19: Slide the black protective sleeve 118 over the tether grip assembly 110 by pulling it from the end closest to the thimble 120. Slide the protective sleeve 118 up until it reaches the area between the clear label heat shrink and the upper layer of cold shrink tube 124 closest to the thimble 120. Secure the protective sleeve 118 with electrical tape, or other means such as heat shrink tubing, wire wrapping, clamps, etc., wrapped around the sleeve 118 under tension, overlapping one to two inches on each side of the end of the sleeve, leaving a folded over flag so the tape is easily removed for inspection.

Step 20: Continue to pull the sleeve 118 toward the thimble 120 until the other end reaches the ridge created at the tail end of the tether grip assembly 110 under the center of the cold shrink tube 124. Secure the sleeve in place with electrical tape, or other means such as heat shrink tubing, wire wrapping, clamps, etc., overlapping each way one to two inches, leaving a folded over flag so the tape is easily removed for inspection.

Step 21: Remove the fid 105. For threaded embodiments of the fid 105, remove the fid 105 by turning the fid 105 in a counter-clockwise direction.

Step 22: With the loop of the steel cable grip 136 positioned towards the end of the tether 108, push the loop onto the tether 108 approximately 10 feet from the end of the tether 108. Secure the tail end of the steel cable grip 136 with electrical tape, or other means such as heat shrink tubing, wire wrapping, clamps, etc., overlapping one to two inches on each side of the tail end of the tether grip assembly 110.

Step 23: Perform electrical and fiber optic termination as is known in the art.

### Various Notes & Examples

Example 1 can include a method of securing a tether to a buoyant inflatable device. The method can include the steps of providing a tether grip assembly comprising an eye with a support thimble, coupling the tether with the tether grip assembly, and latching the buoyant inflatable device to a support thimble of the tether grip assembly. The tether grip assembly is configured for coupling with the buoyant inflatable device by routing the tether through a tether passage of the tether grip assembly surrounded by a braided shell of the tether grip assembly, penetrating the tether through the braided shell at an emergence point, and delivering a first portion of the tether through the emergence point in the braided shell and retaining a second portion of the tether in the tether passage;

Example 2 can include, or can optionally be combined with the subject matter of Example 1 to optionally include that the step of installing a fid onto an end of the tether before routing it through the tether passage and penetrating the braided shell.

Example 3 can include, or can optionally be combined with the subject matter of one or any combination of Examples 1-2 to optionally include that installing a fid onto an end of the tether comprises screwing the fid onto the end of the tether with internal threading at an end of the fid.

Example 4 can include, or can optionally be combined with the subject matter of one or any combination of Examples 1-3 to optionally include that the braided shell is configured to transform a tensile load incident on the tether and the braided shell to a compressive load around the tether with the braided shell.

Example 5 can include, or can optionally be combined with the subject matter of one or any combination of Examples 1-4 to optionally include the step of routing the first portion to the buoyant inflatable device.

Example 6 can include, or can optionally be combined with the subject matter of one or any combination of Examples 1-5 to optionally include that the tether includes a power channel and a communication channel.

Example 7 can include, or can optionally be combined with the subject matter of one or any combination of Examples 1-6 to optionally include that the power channel and communication channel are exposed at a point near the buoyant inflatable device and are coupled to the buoyant inflatable device, thereby providing power and communication to the buoyant inflatable device.

Example 8 can include, or can optionally be combined with the subject matter of one or any combination of Examples 1-7 to optionally include the step of securing a cable support grip to the first portion of the tether proximate the buoyant inflatable device, the cable support grip providing strain relief for the tether.

Example 9 can include, or can optionally be combined with the subject matter of one or any combination of Examples 1-8 to optionally include the step of securing an anchor sleeve around the tether grip assembly, the anchor sleeve extending toward the support thimble and anchoring a support thimble within the grip's eye.

Example 10 can include, or can optionally be combined with the subject matter of one or any combination of Examples 1-9 to optionally include the step of applying a sleeve around the tether grip assembly between the tail portion of the grip and the eye of the grip.

Example 11 can include, or can optionally be combined with the subject matter of one or any combination of Examples 1-10 to optionally include the step of providing a first wrap around the braided shell and the tether proximate the entrance to the tether passage and providing a second wrap around the tether grip assembly and a length of the tether that has been routed through the wall of the braided shell, the second wrap positioned proximate the emergence point.

Example 12 can include or can optionally be combined with the subject matter of one or any combination of Examples 1-11 to optionally include a system for tethering a buoyant inflatable device to a ground platform that includes a winch, a tether that includes a first end secured to the winch, and a tether grip assembly. The tether grip assembly can include a hollow portion and an eye with a thimble that is secured to the buoyant inflatable device. The hollow portion may include a braided shell and a tether passage surrounded by the braided shell. The tether extends within the braided shell along at least a portion of the tether passage for a first distance, and the tether emerges through the braided shell at an emergence point, and the braided shell grasps the tether along at least the first distance.

Example 13 can include, or can optionally be combined with the subject matter of one of any combination of Example 1-12 to optionally include a cable support grip that is positioned between the buoyant inflatable device and the tether grip assembly, where the cable support grip positioned proximate a second end of the tether opposite the first end, and provides strain relief for the tether.

Example 14 can include, or can optionally be combined with the subject matter of one or any combination of Examples 1-13 to optionally include that the tether includes a power channel and a communication channel.

Example 15 can include, or can optionally be combined with the subject matter of one or any combination of Examples 1-14 to optionally include a power channel that includes a power line and a communication channel that includes a fiber optic cable.

Example 16 can include, or can optionally be combined with the subject matter of one or any combination of Examples 1-15 to optionally include a tether that includes aromatic polyester strength members.

Example 17 can include, or can optionally be combined with the subject matter of one or any combination of Examples 1-16 to optionally include the thimble being made of stainless steel.

Example 18 can include, or can optionally be combined with the subject matter of one or any combination of Examples 1-17 to optionally include the braided shell being configured to transform a tensile load incident on the tether and the braided shell to a compressive load around the tether with the braided shell.

Example 19 can include, or can optionally be combined with the subject matter of one or any combination of Examples 1-18 to optionally include the tether grip assembly further including a sleeve positioned around the tether grip assembly between a tail portion of the grip and the eye of the grip.

Example 20 can include, or can optionally be combined with the subject matter of one or any combination of Examples 1-19 to optionally include that the system has an average breaking strength of greater than 15,000 lbf.

Example 21 can include, or can optionally be combined with the subject matter of one or any combination of Examples 1-20 to optionally include that the tether grip assembly comprises an abrasion and UV resistant para-ararnid fiber.

Example 22 can include or can optionally be combined with the subject matter of one or any combination of Examples 1-21 to optionally include a tether grip kit for use with a buoyant inflatable system. The tether grip kit can include a tether grip assembly configured to grasp a tether and a support thimble. The tether grip assembly includes a hollow portion that includes a braided shell and a tether passage surrounded by the braided shell. The tether grip assembly is configured to interface with the tether in at least two installation states, where in the first installation state an end of the tether is inserted into the tether passage, and in the second installation state the end of the tether extends towards the aerostat and through a wall of the braided shell.

Example 23 can include, or can optionally be combined with the subject matter of one or any combination of Examples 1-22, to optionally include an anchor sleeve coupled around the tether grip assembly, such that the anchor sleeve extends toward the support thimble and anchors a thimble portion of the grip around the support thimble.

Example 24 can include, or can optionally be combined with the subject matter of one or any combination of Examples 1-23 to optionally include the support thimble being made of stainless steel.

Example 25 can include, or can optionally be combined with the subject matter of one or any combination of Examples 1-24 to optionally include the anchor sleeve being made of rubber.

Example 26 can include, or can optionally be combined with the subject matter of one or any combination of Examples 1-25 to optionally include the anchor sleeve including cold shrink material.

Example 27 can include, or can optionally be combined with the subject matter of one or any combination of Examples 1-26 to optionally include a nylon sleeve that extends from the tether's entry point to the tether passage to a point proximate the eye, where the nylon sleeve provides UV protection for the grip.

Example 28 can include, or can optionally be combined with the subject matter of one or any combination of Examples 1-27 to optionally include a fid configured for coupling with the end of the tether, wherein the braided shell includes one or perforations configured to receive and pass the fid and tether from the tether passage therethrough.

Example 29 can include, or can optionally be combined with the subject matter of one or any combination of Examples 1-28 to optionally include that in the second installation state at an emergence point to the aerostat, a portion of the tether outside the braided shell positioned between an emergence point from the wall of the braid and the eye of the tether is secured to the tether grip assembly with a wrap.

Example 30 can include, or can optionally be combined with the subject matter of one or any combination of Examples 1-29 to optionally include that the tether grip assembly has an average breaking strength of greater than 10,000 lbf.

Example 31 can include, or can optionally be combined with the subject matter of one or any combination of Examples 1-30 to optionally include that the tether grip assembly has an average breaking strength of greater than 15,000 lbf,

Example 32 can include, or can optionally be combined with the subject matter of one or any combination of Examples 1-31 to optionally include that the braided shell comprises an abrasion and UV-resistant para-aramid fiber.

Each of these non-limiting examples can stand on its own, or can be combined in various permutations or combinations with one or more of the other examples. In the examples, the terms “a” and “the” are used interchangeably, such that reference to “the tether” in a given example can refer to a tether described in a previous example that is optionally combined with the given example, or can refer to a separate tether entirely. Similarly “a tether” can refer to a newly introduced tether, or to a tether described in a previous example.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled,

What is claimed is:

1. A method of securing a tether to a buoyant inflatable device, comprising:
providing a tether grip assembly comprising an eye with a support thimble;
coupling the tether with the tether grip assembly, the tether grip assembly configured for coupling with the buoyant inflatable device by:
routing the tether through a tether passage of the tether grip assembly surrounded by a braided shell of the tether grip assembly,
penetrating the tether through the braided shell at an emergence point, and
delivering a first portion of the tether through the emergence point in the braided shell and retaining a second portion of the tether in the tether passage; and
latching the buoyant inflatable device to the support thimble of the tether grip assembly.

2. The method of claim 1, further comprising installing a fid onto an end of the tether before routing it through the tether passage and penetrating the braided shell.

3. The method of claim 2, wherein installing a fid onto an end of the tether comprises screwing the fid onto the end of the tether with internal threading at an end of the fid.

4. The method of claim 1, wherein the braided shell is configured to transform a tensile load incident on the tether and the braided shell to a compressive load around the tether with the braided shell.

5. The method of claim 1, further comprising routing the first portion to the buoyant inflatable device.

6. The method of claim 5, wherein the tether comprises a power channel and a communication channel.

7. The method of claim 6, wherein the power channel and communication channel are exposed at a point near the buoyant inflatable device and are coupled to the buoyant inflatable device, thereby providing power and communication to the buoyant inflatable device.

8. The method of claim 7, further comprising securing a cable support grip to the first portion of the tether proximate the buoyant inflatable device, the cable support grip providing strain relief for the tether.

9. The method of claim 1, further comprising securing an anchor sleeve around the tether grip assembly, the anchor sleeve extending toward the support thimble and anchoring the support thimble within the eye.

10. The method of claim 1, further comprising applying a sleeve around the tether grip assembly between the tail portion of the grip and the eye of the grip.

11. The method of claim 1, further comprising providing a first wrap around the braided shell and the tether proximate the entrance to the tether passage and providing a second wrap around the tether grip assembly and a length of the tether that has been routed through the wall of the braided shell, the second wrap positioned proximate the emergence point.

12. A system for tethering a buoyant inflatable device to a ground platform, comprising:
a winch;
a tether comprising a first end secured to the winch;
a tether grip assembly; the tether grip assembly comprising:
a hollow portion comprising:
a braided shell, and
a tether passage surrounded by the braided shell, and
an eye with a thimble that is secured to the buoyant inflatable device;
wherein the tether extends within the braided shell along at least a portion of the tether passage for a first distance, and the tether emerges through the braided shell at an emergence point, and the braided shell grasps the tether along at least the first distance.

13. The system of claim 12, further comprising a cable support grip that is positioned between the buoyant inflatable device and the tether grip assembly, the cable support grip positioned proximate a second end of the tether opposite the first end, and providing strain relief for the tether.

14. The system of claim 12, wherein the tether comprises a power channel and a communication channel.

15. The system of claim 14, wherein the power channel comprises a power line and the communication channel comprises a fiber optic cable.

16. The system of claim 12, wherein the tether comprises aromatic polyester strength members.

17. The system of claim 12, wherein the thimble comprises stainless steel.

18. The system of claim 12, wherein the braided shell is configured to transform a tensile load incident on the tether and the braided shell to a compressive load around the tether with the braided shell.

19. The system of claim 12, wherein the tether grip assembly further comprises a sleeve positioned around the tether grip assembly between a tail portion of the grip and the eye of the grip.

20. The system of claim 12, wherein the system has an average breaking strength of greater than 10,000 lbf.

21. The system of claim 12, wherein the tether grip assembly comprises an abrasion and UV resistant nylon.

22. A tether grip kit for use with a buoyant inflatable system, comprising:
a tether grip assembly configured to grasp a tether, the tether grip assembly comprising,
a hollow portion, the hollow portion comprising:
a braided shell, and
a tether passage surrounded by the braided shell; and
a support thimble with an eye extending through the support thimble, and a thimble portion of the tether grip assembly extending around the support thimble,
wherein the tether grip assembly is configured to interface with the tether in at least two installation states, where:
in the first installation state an end of the tether is inserted into the tether passage, and
in the second installation state the end of the tether extends towards the aerostat and through a wall of the braided shell.

23. The tether grip kit of claim 22, further comprising an anchor sleeve coupled around the tether grip assembly, the anchor sleeve extending toward the support thimble and anchoring the support thimble within the eye.

24. The tether grip kit of claim 24, wherein the support thimble comprises stainless steel.

25. The tether grip kit of claim 24, wherein the anchor sleeve comprises rubber.

26. The tether grip kit of claim 24, wherein the anchor sleeve comprises cold shrink material.

27. The tether grip kit of claim 22, further comprising a nylon sleeve that extends from an entry point of the tether into the tether passage to a point proximate the eye, wherein the nylon sleeve provides UV protection for the grip.

28. The tether grip kit of claim 22, further comprising a fid configured for coupling with the end of the tether, wherein the braided shell includes one or more perforations configured to receive and pass the fid and tether from the tether passage therethrough.

29. The tether grip kit of claim 22, wherein in the second installation state at an emergence point to the aerostat, a portion of the tether outside the braided shell positioned between an emergence point from a wall of a braid in the braided shell and the eye of the tether is secured to the tether grip assembly with a wrap.

30. The tether grip kit of claim 22, wherein the tether grip assembly has an average breaking strength of greater than 10,000 lbf.

31. The tether grip kit of claim 30, wherein the hollow portion of the tether grip assembly has an average breaking strength of greater than 15,000 lbf.

32. The tether grip kit of claim 30, wherein the braided shell comprises an abrasion and UV-resistant para-aramid fiber.
